(19) United States
(12) Patent Application Publication
(10) Pub. No.: US 2015/0032584 A1
(43) Pub. Date: Jan. 29, 2015

(54) METHODS AND SYSTEMS FOR COLLECTING FEES FROM A MERCHANT AND REMITTING THE FEES TO AN ADMINISTRATIVE AGENCY

(71) Applicant: United States Postal Service, Washington, DC (US)

(72) Inventor: James DeForrest Wilson, Collierville, TN (US)

(21) Appl. No.: 14/340,080

(22) Filed: Jul. 24, 2014

Related U.S. Application Data
(60) Provisional application No. 61/858,511, filed on Jul. 25, 2013.

(51) Int. Cl. G06Q 40/00; G06Q 10/08

(52) U.S. Cl. CPC G06Q 40/123; G06Q 10/0835
USPC 705/31

(57) ABSTRACT

The present disclosure provides systems, processes, and methods for the remittance of sales tax to a government entity on behalf of a first entity, such as a merchant, for a remote purchase of a product made by a second entity, such as a buyer. The merchant may be in electronic communication with the buyer to receive the order from the buyer. An item distributor may be in electronic communication with the merchant and may receive data over a network associated with the purchase transaction. The distributor may receive the item from the merchant to be delivered to a shipping address provided by the buyer. The item distributor may receive the sales tax from the merchant for remittance to the government entity and may remit the sales tax to the government entity, along with the necessary associated data and/or documentation, on behalf of the merchant. The sales tax, along with the associated data and documentation may be submitted electronically over a network to a government system configured to receive such sales tax and data.

### CLAIM OF PRIORITY

Any and all applications for which a foreign or domestic priority claim is identified in the Application Data Sheet as filed with the present application are hereby incorporated by reference under 37 CFR 1.57. This application claims priority to and the benefit of U.S. Provisional Application 61/858,511, filed Jul. 25, 2013, the entire contents of which are hereby incorporated by reference.

### BACKGROUND

1. Field of the Development

This application relates to methods, processes, and systems for remitting sales tax to a government entity on behalf of an entity, such as an online merchant, by an item distributor, for purchases made remotely by a buyer.

2. Description of the Related Art And Problem to be Solved

The proliferation of the internet has allowed buyers in one location to purchase products from online merchants and retailers often located in other locations that are remote from the buyer. Under the laws of many states, if an online merchant has a physical presence (such as a store, business office, or warehouse) in a particular state, it must collect sales tax from customers located in that state for online purchases even if the online transaction is completed with an office of the merchant located outside of the state.

Historically, if a merchant has not had a physical presence in a state, the merchant has not been required to collect sales tax for sales made in that state. In many states, even when a merchant does not collect sales tax, the buyers are technically responsible for remitting any unpaid sales tax on online purchases directly to their state in the form of a “use tax.” The reality is that buyers rarely remit the use tax to their state governments. State governments have sought ways to capture this lost source of revenue. Recently many state governments and the federal government have taken additional steps to require online merchants to collect sales tax for purchases made over the internet by buyers in other states.

New legislation may require the online merchants to remit sales tax to all states and/or local cities and tax-collecting jurisdictions to which they ship their products. These new requirements may place a significant burden on small and larger merchants alike to calculate, collect, and remit the sales tax to the individual states. Online merchants would have to be familiar with the sales tax rates for the various jurisdictions within each state, the merchants would have to tabulate and account for the amount of sales tax to be remitted to each state and local jurisdiction, and the merchants would have to remit the sales tax to each state and taxing jurisdiction along with the associated data and required documentation in order meet state or other reporting requirements. Such reporting requirements may vary from state to state and jurisdiction to jurisdiction.

### SUMMARY

Embodiments disclosed herein relate to methods of collecting and remitting a fee on behalf of a first entity, such as a merchant, for a purchase transaction made by a second entity, such as a buyer, from the first entity. The methods can include receiving a distribution item from the first entity for delivery to a shipping address, the distribution item comprising a distribution item ID and an indicia, wherein the distribution item ID comprises a merchant ID associated with the first entity and the indicia represents an amount comprising at least the fee amount for the purchase transaction. The methods can also include receiving distribution item data, the data comprising the distribution item ID, the merchant ID, and the fee amount associated with the purchase transaction. The methods can also include storing the distribution item ID, the merchant ID, and the fee amount in a memory, and associating the fee amount for the purchase transaction with the merchant ID and the distribution item ID in the memory.

The methods can also include delivering the distribution item to the shipping address, and transmitting the merchant ID and the fee amount associated with the distribution item ID to a government entity, and remitting the fee to the government entity on behalf of the merchant.

In certain embodiments, receiving distribution item data may comprise receiving electronic transmittal data from the first entity. In certain embodiments, receiving distribution item data may include scanning the distribution item ID on the distribution item.

In certain embodiments, the indicia may be in the form of postage affixed to the distribution item. The indicia may represent an amount further including the shipping amount for the distribution item. The indicia may indicate a total amount comprising the shipping amount and the fee amount. Also, the indicia may separately indicate the shipping amount and the fee amount.

In certain embodiments, the methods may further include accruing the fee received for multiple purchase transactions for a merchant prior to transmitting the merchant ID and the fee amount to the government entity and prior to remitting the fee to the government entity on behalf of the merchant. The methods may include receiving payment from the first entity for the cost of the indicia.

The methods may include receiving purchase transaction data from the first entity, such that the purchase transaction data includes the shipping address. The methods may include determining a sales tax rate and a shipping amount based on the shipping address, and electronically transmitting the sales tax rate and the shipping amount to the first entity. In certain embodiments, the methods may include receiving purchase transaction data from the first entity, such that the purchase transaction data includes the shipping address and a transaction amount. The methods may include determining a sales tax amount and a shipping amount on behalf of the first entity based on the transaction amount and the shipping address, and electronically transmitting the sales tax amount and the shipping amount to the first entity.

In certain embodiments, the government entity may be a state government or a county government. In certain embodiments, the shipping address and the first entity may be located in the same state. Or the shipping address and the first entity may be located in different states.

System disclosed herein may include a system for collecting sales tax from a merchant for a purchase transaction between the merchant and a buyer and remitting the sales tax to a government entity on behalf of the merchant. The system may include a memory, a distribution module stored in the memory and configured to receive and store distribution item data associated with a distribution item, the distribution item data including a distribution item ID, a merchant ID associated with the merchant, and an indicia amount associated with the distribution item, the indicia amount including at least the sales tax amount associated with the purchase transaction. The system may include a sales tax module stored in the memory and in communication with the distribution module and configured to receive and store at least the sales tax amount associated with a merchant ID. The system may also include a network component in communication with a merchant system and configured to receive the distribution item data from the merchant system. The network component may be in communication with a government entity system and configured to transmit data associated with the purchase transaction to the government entity. In certain embodiments, the indicia amount stored in the distribution model may include the shipping amount associated with the distribution item.

The system may also include a scanner, such that the scanner is configured to obtain the distribution item data from the distribution item. The system may also include a scan module, such that the scan module is in communication with the scanner, wherein the scan module is in communication with the distribution module to provide distribution item data to the distribution module.

In certain embodiments, the distribution item data stored in the distribution module may include the sales tax amount and the indicia amount may include the shipping amount associated with the distribution item. In certain embodiments, the distribution item data stored in the distribution module may include the shipping amount.

The system may also include a merchant data module stored in memory and configured to receive a shipping address and a purchase price associated with the purchase transaction from the merchant system. The system may also include a processing component in the merchant data module configured to calculate and store at least a sales tax amount associated with the purchase transaction based on the shipping address and the purchase price. In certain embodiments, the network component may be configured to transmit the sales tax amount to the merchant system.

### BRIEF DESCRIPTION OF THE DRAWINGS

FIG. 1 is an example of a system for remittance of sales tax by a distributor on behalf of a merchant for a product purchased by a buyer.

FIG. 2 is a flow diagram illustrating one example of a process for a distributor to remit sales tax on behalf of a merchant.

FIG. 3 is a flow diagram illustrating one example of a process for a merchant to provide sales tax to a distributor for remittance to a government entity

FIG. 4 is a flow diagram illustrating an example of a process facilitating a credit of sales tax to a merchant for a returned item.

FIG. 5 depicts a block diagram of an embodiment of a distributor system for remittance of sales tax by a distributor on behalf of a merchant.

### DETAILED DESCRIPTION

The following detailed description is directed to certain specific embodiments of the development. In this description, reference is made to the drawings wherein like parts or steps may be designated with like numerals throughout for clarity. Reference in this specification to “one embodiment,” “an embodiment,” or “in some embodiments” means that a particular feature, structure, or characteristic described in connection with the embodiment is included in at least one embodiment of the invention. The appearances of the phrases “one embodiment,” “an embodiment,” or “in some embodiments” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Certain embodiments described herein can be used to address the burden that an online merchant may experience in accounting for sales tax collected from buyers in states in which the merchant does not have a physical or business presence and remitting the sales tax received to the various state and local governments or other administrative agencies.

To address the burden of remitting sales tax to the government entity, a distributor (e.g., a shipping or parcel delivery company, or the like) may collect the sales tax from the merchant in the form of a fee (e.g., postage or the like) payable to the distributor and remit the sales tax to the government entity on the merchant's behalf. The sales tax collected from the buyer may be, for example, a state sales tax, a county sales tax, a municipal sales tax, or may be associated with a special tax district, or may be any other tax, assessment, levy, fee, or surcharge associated with a transaction. Although the term sales tax is used throughout, it should be understand that the term is being used throughout for convenience to convey that the fee received from the buyer may include any of these fees, taxes, or charges. Thus, the sales tax collected by the merchant from the buyer may be a total amount that is the sum of any of these tax amounts or other fees or charges.

Although the term government entity is used herein, it should be understand that the term is being throughout for convenience to convey that the entity receiving the fee may be a state, county, local, or municipal government entity or may be an administrative agency otherwise designated to receive from the merchant the fee associated with the transaction. It is also contemplated that the entity receiving the fee may be another business. In one embodiment, the entity may be a service provider designated to receive such fees on behalf of the government entity.

The examples and illustrations provided herein describe systems and processes by which the distributor may remit sales tax on the merchant's behalf. In certain embodiments disclosed herein, the distributor may also submit all necessary data and documentation associated with the sales tax remittance to the government entity on behalf of the merchant. Data and documentation that a distributor may submit on behalf of the merchant include, but are not limited to, the sales tax amount, the merchant name, the merchant address, the merchant taxpayer identification number, and any other data or documentation required by the government entity.

In some embodiments, the distributor may also provide to the merchant the sales tax rates or sale tax amounts for purchases made by a buyer online. When a shipping address is input by a buyer during an online purchase, the merchant's system may receive the sales tax rate from the distributor's system in order to calculate the sales tax for the purchase. That is, in some embodiments, the distributor may provide the sales tax rate to the merchant's system based on the shipping address provided by the buyer. The sales tax rate may be a function of the shipping address provided by the buyer during the transaction and more particularly may be a function of one portion of the shipping address, such as, for example, the ZIP code of the shipping address. In one embodiment, the sales tax rate may be based on the ZIP+4 system used by a distributor, such as the United States Postal Service. In certain embodiments, the sales tax rates for the ZIP+4 localities may be provided as data to the merchant and may be updated by the distributor when sales tax rates are changed by the respective government entities.

By shifting the sales tax remittance responsibility to the distributor, a merchant may be relieved of the responsibility of remitting sales tax to the government entities in any state to which the merchant ships its products. Moreover, the merchant may be relieved from having to prepare and submit sales tax data and documentation to any state to which the merchant ships its products. The merchant may also be free from having to store and upkeep sales tax rates for the different jurisdictions and addresses throughout the country. The merchant may also be free from having to compute the tax due.

The disclosure provided herein includes systems and processes for accomplishing the objectives of the disclosure. The figures associated with the disclosure show process flow diagrams illustrating examples of the embodiments disclosed herein. In the figures, many operations are illustrated as being performed sequentially. It will be appreciated however that the operations may be re-ordered as convenient to suit particular embodiments, and that some operations may be performed concurrently in some embodiments. It will also be appreciated that some operations are optional to the successful completion of the processes.

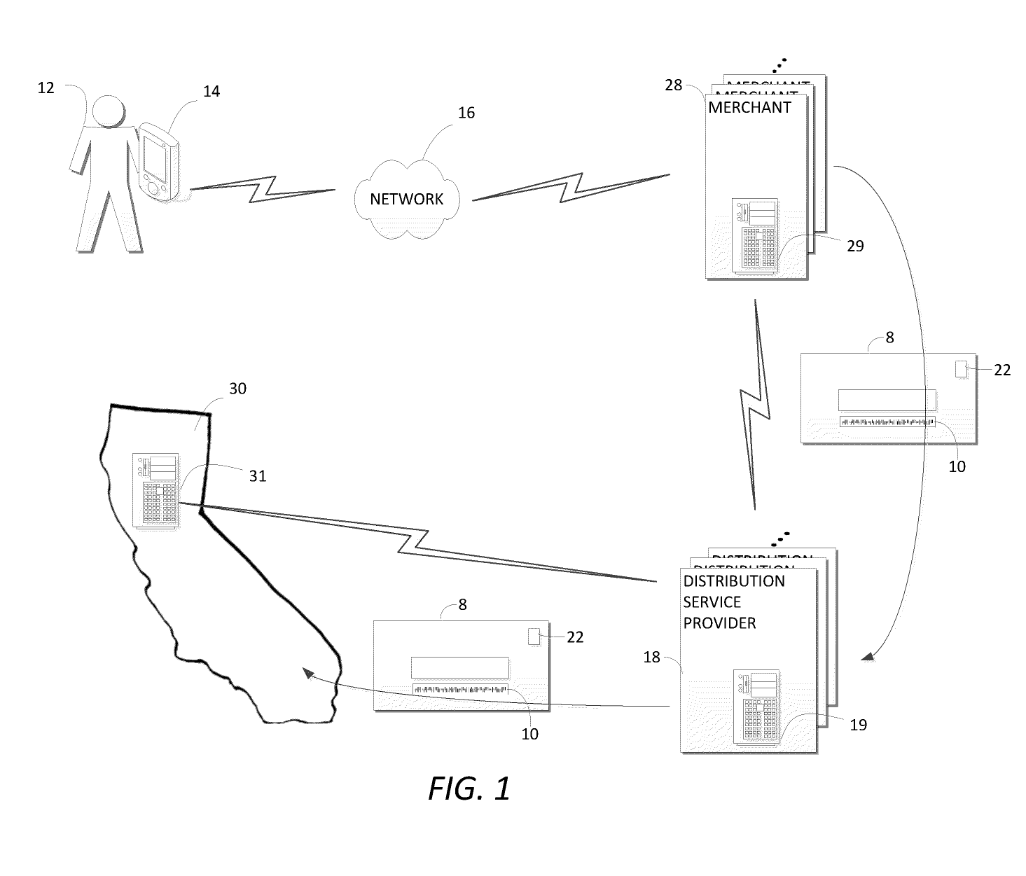

With reference now to FIG. 1, an example of a system that may be utilized for remittance of sales tax to a government entity 30 will be described. In the system shown, the sales tax may be remitted to the government entity 30 by a distribution service provider 18 (e.g., a distributor, such as a parcel delivery service) on behalf of a merchant 28 for a product purchased by a buyer 12. In some embodiments, a buyer 12 may be an individual or any entity using a communication or computing device 14 to send data over a network 16 to a merchant 28 to place an order for a product sold by the merchant. The computing device 14 may be a smart phone, a PDA, a laptop, a desktop computer, a tablet computer, or the like. The computing device 14 may include communication components for facilitating communication via wired and wireless communication networks, such as the network 16. The computing device 14 may also include an input device, such as a keyboard, and a display unit, such as an LED screen.

The buyer's computing device 14 may be in communication with the merchant system 29 through the network 16. The merchant system 29 may be the merchant's system for receiving and processing orders. The merchant system may include networks, processing systems, servers, software, databases, etc. for receiving, processing, and fulfilling orders received for products. While the merchant system 29 in FIG. 1 may be depicted by a single computing device, this is illustrative only. The merchant system 29 may be embodied in a plurality of computing devices. A server or other computing device implementing the merchant system 29 may include memory, processing unit(s), and computer readable medium drive(s), all of which may communicate with one another by way of a communication bus. A network interface may provide connectivity over the network or other networks or computer systems of the merchant system 29. The processing unit(s) may communicate to and from memory containing program instructions that the processing unit(s) executes in order to operate the merchant system 29. The memory generally includes RAM, ROM, and/or persistent and auxiliary memory.

The merchant 28 utilizing the processes and systems disclosed herein may be an online retailer of any size. The disclosure herein provides no limitations on the products sold by the merchant. The merchant 28 may be also an individual or entity selling a product or products through a third-party website or service (such as, for example, ebay.com or craigslist.com). The merchant 28 may sell items online to be delivered to shipping addresses throughout the United States, and even internationally. The merchant 28 may sell its products online through a website or may offer its products for sale through a mobile phone application.

The merchant system 29 may be in communication with the distributor system 19 through a wired or wireless network. The distributor system 19 may be part of a distributor system including networks, processing systems, servers, software, databases, etc. for sending and receiving data associated with distribution items to be delivered. The distributor system 19 may also include systems and functionality for sending and receiving data associated with sales tax to be remitted to the government entity 30 (for example to a government entity system 31), as well as, data and documentation to be generated and provided to the government entity 30 on behalf of the merchant 28. The distributor system 19 may be embodied in a plurality of computing devices. A server or other computing device implementing the distributor system 19 may include memory, processing unit(s), and computer readable medium drive(s), all of which may communicate with one another by way of a communication bus. A network interface may provide connectivity over the network or other networks or computer systems of the distributor system 19. The processing unit(s) may communicate to and from memory containing program instructions that the processing unit(s) executes in order to operate the distributor system 19. The memory generally includes RAM, ROM, and/or persistent and auxiliary memory.

It will be appreciated by the person of skill in the art that the distributor 18 may be a regional, national, or international parcel delivery service provider. In one non-limiting embodiment, the distributor may be the United States Postal Service.

As shown in FIG. 1, the distributor system 19 may also be in communication with the government entity system 31 through a wired or wireless network. The government entity system 31 may be part of a government entity system 31 including networks, processing systems, servers, software, databases, etc. for receiving and processing sales tax data received from a distributor system 19, or other such entity remitting sales tax, and the associated data and documentation. The government entity system 31 may be embodied in a plurality of computing devices. A server or other computing device implementing the government entity system 31 may include memory, processing unit(s), and computer readable medium drive(s), all of which may communicate with one another by way of a communication bus. A network interface may provide connectivity over the network or other networks or computer systems of the government entity system 31. The processing unit(s) may communicate to and from memory containing program instructions that the processing unit(s) executes in order to operate the government entity system 31. The memory generally includes RAM, ROM, and/or persistent and auxiliary memory.

A person of skill in the art will appreciate that the government entity 30 may be a state government (or an agency, department, division, etc. of the state government). In certain embodiments, the government entity 30 may be a county or municipal government (or an agency, department, division, etc. thereof).

Examples of various wired and wireless communication protocols that may be used over the network 14 and between the merchant system 29, the distributor system 19, and the government entity system 31 include, but are not limited to, Bluetooth, the family of IEEE 802.11 technical standards (“wifi”), the IEEE 802.16 standards (“WiMax”), short message service (“SMS”), voice over IP (“VoIP”) as well as various generation cellular air interface protocols (including, but not limited to, air interface protocols based on CDMA, TDMA, GSM, WDCMA, CDMA2000, TD-SCDMA, WTDMA, LTE, OFDMA, and similar technologies). The network communications may also include, but are not limited to, wired networks such as cable, DSL, fiber optic, standard phone line, etc.

According to the system shown in FIG. 1, the buyer 12 may transmit data over the network 16 from the computing device 14 to the merchant system 29 to place the order and purchase the product. The data transmitted by the buyer may be, for example, the selection of the product on the merchant's website or app, the quantity of products, the buyer's billing information, credit card information, the buyer's selected shipping address, and the like.

The data associated with the order for the product may be received by the merchant system 29. As part of the order processing, the merchant 28 may transmit back to the buyer 12, a total price for the transaction, including any sales tax amount and shipping amount. The merchant 28 may calculate the sales tax amount and shipping amount through its system 29, or may rely on a third party system, such as the distributor system 19, to determine the sales tax amount and/or the shipping amount. The sales tax rate may be, for example, a state sales tax rate, a county sales tax rate, a municipal sales tax rate, or may be associated with a special tax district. The total sales tax calculated may be a total sales tax amount that is the sum of any of these sales tax amounts. The sales tax rates may be, for example, based on the USPS Zip+4 file structure and may be determined based on the shipping address to which the product will be sent.

Based on the shipping address data received from the buyer 12, the merchant may, through its system 29, calculate the sales tax amount for the product or products purchased and the shipping amount. In certain embodiments, the merchant 28 may maintain in its system 29 the shipping rates and the sales tax rates for the various localities throughout the country in order to perform such calculations and then transmit the data back to the buyer over the network. Sales tax rates and shipping rates will likely vary based on the selected shipping address provided by the buyer 12. In certain embodiments, the sales tax rate data and shipping rate data used to calculate the sales tax amount and shipping amount may be providing initially by a third party, such as the distributor 18, and updates may be provided to the merchant system 29 when necessary (such as when sales tax rates or shipping rates change).

In certain other embodiments, the merchant 28 may initially transmit data to the distributor 18 related to the purchase transaction prior to completion of the transaction in order to receive further data from the distributor 18 related to the sales tax and shipping amount for the product being purchased by the buyer 12. For example, before completing the transaction, the merchant 28 may transmit the purchase amount and shipping address for the transaction to the distributor 18 for the distributor 18 to calculate the sales tax rate or amount and/or the shipping amount associated with the product and shipping address. The distributor 18 may perform such calculations in its system 19 and may transmit the sales tax rate or amount and/or shipping amount back to the merchant system 29 for use in completion of the sales transaction. The merchant 28 may then transmit the sales tax amount and shipping amount back to the buyer 12 to be displayed on the buyer's computing device 14.

The buyer 12 may additionally submit payment to the merchant 28 over the network 16 by submitting credit card information to the merchant system 29 or a third-party processing service via the computing device 14. The merchant 28, through its system 29, may complete the purchase transaction and electronically receive payment for the product from the buyer 12. The payment received from the buyer 12 may include the shipping amount and the sales tax amount. The sales tax collected from the buyer 12 may be, for example, a state sales tax, a county sales tax, a municipal sales tax, or may be associated with a special tax district, or may be any other tax, assessment, levy, fee, or surcharge associated with the purchase transaction. The sales tax collected by the merchant 28 from the buyer 12 may be a total sales tax amount that is the sum of any of these sales tax amounts or other charges.

The merchant 28 may generate a unique identification number associated with the purchase transaction. The data associated with the transaction may be stored and recorded by the merchant 28, in for example a database in its system 29. Additional transaction data that may be recorded includes the transaction unique identification number, the product name, the buyer name, the buyer billing information, the shipping address, the quantity, the shipping amount, the sales tax, and the like.

Following completion of the purchase transaction, the merchant 28 may then fulfill the order and prepare the product to be shipped to the shipping address provided by the buyer 12. In one embodiment, such as is shown in FIG. 1, the product may be packaged as part of a distribution item 8. The distribution item 8 may be, for example, a box, package, envelope, letter, or the like. The merchant 28 may place the shipping address on the distribution item 8. Furthermore, the merchant 28 may also affix or print an indicia 22 on the distribution item 8. The indicia 22 may be indicative of payment or may be a form of payment to the distributor 18. In some embodiments, the indicia 22 may be postage (such as, for example, a stamp or stamps) affixed to or printed on the distribution item 8.

A unique identifier, such as a distribution item ID 10, may be assigned to the distribution item 8 and may be affixed to the distribution item 8. In one embodiment, a separate unique identifier may also be assigned to the individual product purchased. In certain embodiments, the distributor 18 may be responsible for assigning the distribution item ID 10 to the distribution item 8. In certain embodiments, the merchant 28 may be responsible for assigning the distribution item ID 10 to the distribution item 8. The merchant 28 or distributor 18 may place the distribution item identifier or ID 10 on the distribution item 8.

The distribution item ID 10 may be generated from software that generates a unique number or symbol or series of symbols that is unique to the specific distribution item 8. While the distribution item ID 10 is shown as a barcode, the distribution item ID 10 may include one or more of encoded values, permits, mailing system markings, images, short-range wireless objects (e.g., objects using RFID and near field communication (NFC)), and any other information or indicia that can be used in some way to identify information about a distribution item 8 or content associated therewith. Affixing a distribution item ID 10 may refer to information that is attached, printed, imprinted, embossed, provided, delivered along with, or any other method of providing information with a distribution item 8 that allows a computing device to extract and/or derive data from the distribution item ID 10.

If the merchant 28 generates and assigns the distribution item ID 10, the distribution item ID 10 for the distribution item 8 may be represented as all or part of an Intelligent Mail barcode in certain embodiments. A portion of an Intelligent Mail barcode may be a mailer ID, which identifies the particular mailer (e.g., the merchant), and a sequence number, which identifies the individual mail piece specific to that mailer ID. The Intelligent Mail barcode may also include a delivery point zip code, which may be the USPS Zip+4 code. In certain other embodiments, other symbologies may be used for the distribution item ID 10, such as, for example, the Information Based Indicia barcode, Intelligent Mail Package Barcode, and the like. In certain embodiments, the distributor 18 may generate a separate unique identifier for the package according its own system for identifying and tracking distribution item 8. The Intelligent Mail barcode system is described in U.S. Pat. No. 8,598,482, the disclosure of which is herein incorporated by reference.

When the distribution item 8 is prepared for delivery it may be provided to the distributor 18 for delivery to the shipping address selected by the buyer 12 during the purchase transaction. In certain embodiments, the product or distribution item 8 may be provided to the distributor 18 through an intermediary entity, rather than directly from the merchant 28. [0045] Referring again to FIG. 1, the merchant 28 may be in communication with the distributor 18 to transmit data to the distributor 18 related to the buyer's purchase transaction and distribution item 8. In some embodiments, the merchant 28 may transmit electronic data to the distributor 18 over a network to the distributor system 19. The data transmitted to the distributor 18 may include, for example, the distribution item ID 10, the merchant ID, the purchase price of the product, the shipping address, the shipping amount, the sales tax amount, the total transaction amount, the transaction unique identifier, and the like.

In certain embodiments, the indicia 22 may be scanned or otherwise read by the distributor 18 when the distribution item 8 is received in order to record the amount of the fee received from the merchant. The distributor 18 may also scan the distribution item ID 10 and record the amount of the fee received and also how much of the fee is associated with the sales tax for the distribution item ID 10. A scanner may be a part of, or in communication with, the distributor system 29. In certain embodiments, a scanner may also be employed by the merchant 28 to obtain and ultimately transmit data associated with the purchase transaction and the distribution item to the distributor system 19. The distributor 8 may record these amounts in distributor system 19 in order to later remit the sales tax received to the government entity 30. The distributor 8 may associate the distribution ID 10 recorded with the sales tax amount recorded, in a database of the distributor system 19.

The merchant 28 may also transmit a fee to the distributor 18. The fee may include the sales tax amount received from the buyer 12 for the sales tax paid for the product purchased. The fee may also include the shipping amount for the cost of shipping the product to the shipping address. In certain embodiments, the fee may be transmitted electronically to the distributor 18 or the distributor's server 19 and may be recorded as a debit to a merchant's account with the distributor 18. The fee may also be paid to the distributor in the form of the indicia 22 placed on the distribution item 8 by the merchant 28. In certain embodiments, the fee may be transmitted to the distributor 18 through an intermediary entity (such as a bank or other financial institution), rather than directly from the merchant 28.

In one embodiment, the distributor 18 may receive the fee from the merchant 28 in the form of an electronic transfer of funds or as a debit to an account established with the distributor 18. The electronic transfer of funds may also include accompanying data to indicate the amount of the funds transferred to be applied to the sales tax that will be remitted on behalf of the merchant 28

Based on the electronic data received from the merchant 28, the distributor 18 may associate the amount of sales tax that has been collected for a certain distribution item ID 10 (for example the one or more products included in the distribution item 8). In this regard, the distributor 18 may collect the sales tax for a merchant 28 to be remitted for a given distribution item 8 and the associated product or products purchased by the buyer 12. The distributor 18 may record and store the sales tax amount in the distributor system 19 to be remitted on behalf of the merchant 28 to a given government entity 30.

As shown in FIG. 1, the distributor 18 may deliver the distribution item 8 to the shipping address in the state designated by the buyer 12. The shipping address may be that of a business, home, or other drop point at which a receiving party may receive the distribution item 8.

The distributor 18 may also remit the sales tax to the government entity 30 on behalf of the merchant 28. As shown in FIG. 1, the distributor 18 may remit such sales tax to the government entity 30 through electronic transmission of funds to a server 31 associated with the government entity 30 or government entity's bank. In certain other embodiments, the distributor 18 may remit the sales tax on behalf of the merchant 28 through payment of a check, wire transfer, etc. As discussed above, the government entity to which the sales tax is to be transmitted may be a state, county, or municipal government. Thus, for a given purchase transaction, the distributor may divide the sales tax received for the transaction according to the amounts required and may remit the sales tax to multiple government entities, as required. Likewise, because a distributor may distribute the distribution items of many different merchants to the same geographic region, the distributor may remit the sales tax of multiple merchants to the same given government entity.

In addition to remitting sales tax on behalf of the merchant 28, the distributor 18 may also remit data or documentation associated with the sales tax remittance on behalf of the merchant. The data or documentation provided to the government entity 30 may include, but is not limited to, a merchant identifier, such as a merchant ID or taxpayer ID, the merchant address, and the amount of sales tax being remitted, etc. Such data or documentation may be transmitted electronically over a network from the distributor system 19 to the government entity system 31. In certain other embodiments, the data or documentation may be sent as paper documents via parcel post or other shipping services. The data and documentation required may vary by state and the distributor 18 may prepare such data and documentation on behalf of the merchant for each state in which the merchant has sold products. That the distributor 18 may remit the sales tax and submit the associated data and documentation on behalf the merchant 28, relieves the merchant 28 of making separate remittances and submissions to different states.

In certain embodiments of the system shown in FIG. 1, a third-party service provider may be responsible for assisting the distributor 18 in conducting one or more functions of the system. For example, in one embodiment, the merchant 28 may transmit the data associated with the purchase transaction to the third-party service provider. The third-party service provider may then transfer the appropriate data to the distributor 18 on behalf of the merchant 28. Furthermore, the merchant 28, may provide the distribution item 8 to the third-party service provider to be given to the distributor 18. Additionally, in certain embodiments, the merchant 28 may first provide the sales tax payment to the third party, who then transfers the sales tax payment to the distributor 18 to be remitted to the government entity 30.

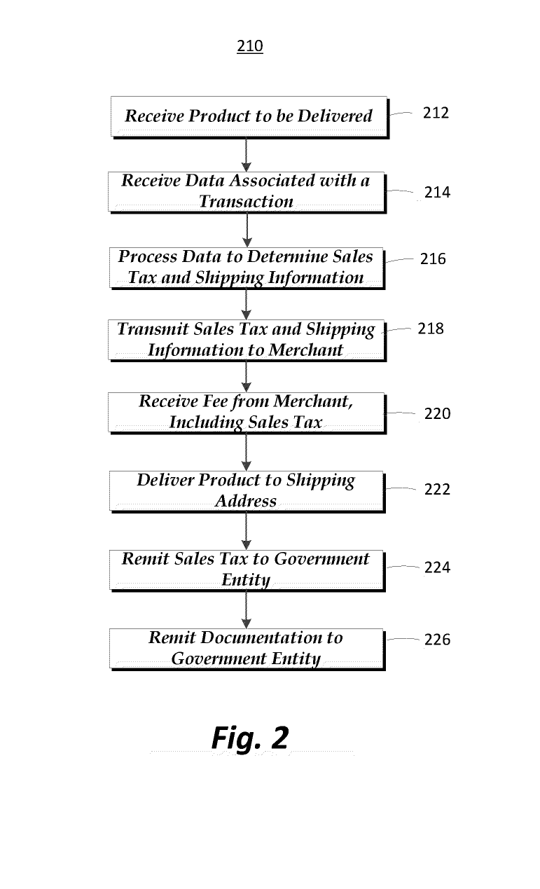

FIG. 2 is a flow diagram representing one example of a process 210 for remitting sales tax on behalf of a merchant for a product purchased over the internet. Process 210 may be implemented through the example system described as part of FIG. 1 or through one or more subsystems shown in FIG. 1. Process 210 is described from the perspective of an item distributor 18, such as, for example, a shipping company or other parcel delivery service. The item distributor 18, for example, may be responsible for performing all or some of the operations of process 210. As illustrated in FIG. 2, process 210 may include one or more functions, operations, or actions as illustrated by one or more operations 212-226.

Process 210 may begin at operation 212, wherein the distributor 18 receives a product from the merchant 28 to be delivered. In some embodiments, the distributor 18 may receive the product from the merchant 28 at, for example, the merchant's office, warehouse, shipping center, or other place of business or at the merchant's home. In some embodiments, the distributor may receive the product for distribution at the distributor's place of business. For example, in such an embodiment, the merchant 28 may transport the product to the distributor 18 and the distributor 18 may subsequently deliver the product to the shipping address designated by the buyer 12. The product may be, or may be contained in, a distribution item 8, such as a package. Thus, in some embodiments the distributor 18 may receive a distribution item 8 from the merchant 28 as part of receiving the product.

In operation 214, the distributor 18 may receive data from the merchant 28 associated with the transaction for the purchase of one or more products. As described above, the data may be received by the distributor system 19 from the merchant system 29 in the form of, for example, a query or data transmission. The data received may include, for example, the transaction ID, the distribution item ID 10, the merchant ID, the purchase price of the product, the shipping address, the transaction unique identifier, and the like. In some embodiments, the data associated with the transaction may be received by the distributor system 19 when a scanner in communication with the distributor system 19 scans the distribution item to retrieve the data associated with the distribution item (including any product information) from the distribution item ID and/or the indicia.

In FIG. 2, at operation 216, “Process Data to Determine Sales Tax and Shipping Information,” the distributor 18 may process the data received from the merchant 28 in the distributor system 19 to determine the sales tax rate or sales tax amount and/or a shipping amount for the purchase transaction. In certain embodiments, the distributor system 19 may generate a query and access a database within the system 19 to determine the sales tax rate or sales tax amount and shipping amount based on at least the shipping address of the purchase transaction. In certain embodiments, the distributor 18 may determine only the sales tax rate, only the sales tax amount, or only the shipping amount in operation 216.

As described above with relation to FIG. 1, the distributor 18 may provide to the merchant 28 the sales tax rate or sales tax amount and/or shipping amount associated with a purchase transaction based on the shipping address provided to the merchant 28 by the buyer 12. For example, as shown in FIG. 2, in operation 218, “Transmit Sales Tax and Shipping Information to Merchant,” the distributor 18 may transmit sales tax information (e.g., sales tax rate or sales tax amount) and shipping information (e.g., shipping amount) to the merchant 28 associated with the purchase transaction in response to the query received from the merchant 28.

In operation 220, the distributor 18 may receive from the merchant 28 a fee, which may include a sales tax amount associated with the product purchased. In certain embodiments, the fee received is sales tax amount alone. In certain embodiments, the fee may also include the shipping amount paid to the distributor for delivering the product to the shipping address. In certain embodiments, the fee received by the distributor 18 from the merchant may be in the form of the indicia 22 affixed to the product or to the distribution item 8 containing the product.

Operation 220 may be followed by operation 222, “Deliver Product to Shipping Address.” The distributor 18 may receive from the merchant 28 the shipping address of the package to be delivered or the shipping address may be determined by the distributor from a label or indicia on the product or distribution item 8. The distributor 18 may then deliver the distribution item 8 to the shipping address.

Operation 222 may be followed by operation 224, “Remit Sales Tax to Government Entity.” Having received the sales tax for the transaction from the merchant 28, the distributor 18 may then remit the sales tax to the appropriate government entity 30 on behalf of the merchant 28. In some embodiments, the sales tax may be remitted on behalf of the merchant 28 after delivering the product to the shipping address. In some embodiments, the sales tax may be collected and recorded and then remitted on a periodic time basis, such as, for example, monthly, quarterly, or yearly.

In operation 226, “Remit Documentation to Government Entity,” the distributor 18 may also, on behalf of the merchant 28, submit all necessary documentation along with the sales tax remittance. For example, the distributor 18 may submit to the government entity 30, along with the sale tax amount, documentation containing the identity of the merchant 28, the name of the merchant 28, a merchant ID, such as a tax payer ID or a mailer ID, the amount of sales tax being remitted, and all other necessary government documentation and forms for remittance of the sales tax.

Operations 212-226 embodied in process 210 may be repeated in part or in whole for additional products purchased by a buyer 12 within a single transaction. Furthermore, the operations 212-226 may be repeated for each subsequent transaction in which the same, or a different buyer 12, purchases products from a merchant 28, and the distributor 18 remits the sales tax collected from the buyer 12 on behalf of the merchant 28 to a government entity 30.

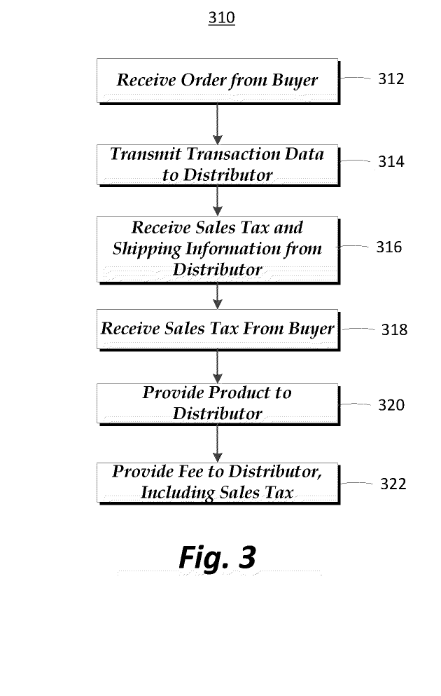

FIG. 3 is a flow diagram representing one example of the process 310 for remitting sales tax on behalf of a merchant 28 for a product purchased remotely. Process 310 is illustrated from the perspective of an online merchant, retailer, or entity who is selling a product remotely, for example, over a network. The merchant 28, for example, may be responsible for performing all or some of the operations of process 310. As illustrated in FIG. 3, process 310 may include one or more functions, operations, or actions as illustrated by one or more operations 312-322.

Process 310 may begin at operation 312, “Receive Order from Buyer.” As disclosed herein, a merchant, retailer, or individual (referred to generally as a merchant 28) may sell a product to a buyer 12 remotely. Operation 312 may include selling a product to a buyer 12 over a network 14. The buyer 12 may search, browse, and select items to be purchased from the merchant's website or mobile phone application or through a third party website or application. The merchant 28 may receive the order for the product at the merchant system 29. In some embodiments, the merchant 28 may receive payment for the product through a credit card transaction. In some embodiments, the merchant 28 may receive a check from the buyer. In some embodiments, an online funds transfer service (e.g., Paypal, etc.) may be used to conduct the payment transaction between the merchant 28 and the buyer 12.

In operation 314, “Transmit Transaction Data to Distributor,” the merchant 28 may transmit data associated with the purchase transaction to the distributor for the distributor to determine the sales tax amount or sales tax rate and/or the shipping amount. The data transmitted to the distributor by the buyer may include, for example, the transaction ID, the distribution item ID 10, the merchant ID, the purchase price of the product, the shipping address, and the like. As described above with relation to FIG. 2, the distributor system 19 may utilize the transmitted data (e.g., the shipping address) to determine the sales tax amount or sales tax rate and/or the shipping amount for the purchase transaction.

As shown in operation 316, “Receive Sales Tax and Shipping Information from Distributor,” the merchant 28 may receive the sales tax and shipping information from the distributor system 19. The merchant 28, through its system 29, may determine a total transaction amount (or the transaction amount may be determined at the distributor system 19 and transmitted to the merchant system 29) and may transmit the total transaction amount, along with the sales tax amount and the shipping amount to the buyer 12.

Operation 318 of process 310 is “Receive Sales Tax from Buyer.” In operation 314, the merchant 28 may collect and receive sales tax from the buyer 12 as part of the sales transaction of the product. As described above with relation to FIG. 1, the sales tax may be received as part of the sales transaction of the product. The sales tax amount may be calculated based on the shipping address provided to the merchant 28 by the buyer 12.

Once the order is received by the merchant 28 and the sales transaction has been completed including receipt of the sales tax from the buyer 12, the merchant 28 may fulfill the order by preparing the product to be delivered to the shipping address designated by the buyer 12. In some embodiments, the merchant may include the purchased product as part of a distribution item 8 (such as a box, package, envelope, etc.). The product itself or the distribution item 8 may be labeled for delivery by the distributor. The label may include the shipping address designated by the buyer. The merchant may also include the unique identifier, such as the distribution item ID 10, on the product or distribution item 8, the distribution item ID 10 being assigned by the merchant 28 or the distributor 18, as described above. The merchant 28 may also affix an indicia (e.g., postage) to the product or distribution item 8 to indicate payment of the shipping amount and sales tax amount. The indicia 22 may be created by the merchant system 29 in response to the input to the merchant system 29 of the distribution item data, such as for example, the shipping address.

In certain embodiments, the distributor 18 may generate the indicia on behalf of the merchant 28. For example, the merchant 28 may provide the distribution item 8 to the distributor 18 for determining the indicia amount and affixing the indicia 22 to the distribution item 8.

In operation 320, “Provide Product to Distributor,” the merchant 28 may provide the product or distribution item 8 to the distributor 18 for delivery to the shipping address. In addition, the merchant 28 may provide data associated with the sales transaction of the product to the distributor 18, including, but not limited to the distribution item ID 10, the merchant ID, the purchase price of the product, the shipping address, the shipping amount, the sales tax amount, the total transaction amount, the transaction unique identifier, and the like.

For operation 322, “Provide Fee to Distributor, Including Sales Tax,” the indicia may be used to provide the fee to the distributor 18. In some embodiments, the merchant 28 may provide the fee to the distributor 18 through affixing the indicia to the product or distribution item 8. In some embodiments, the merchant 28 may pay the fee to the distributor 18 as part of an account or with the distributor, such as a debit or credit account. The distributor 18 may then remit the sales tax to the government entity 30 on behalf of the merchant 28, along with any necessary data and/or documentation required by the government entity 30. As described above, the distributor 18 may maintain an account on behalf of the merchant 28 and the distributor 18 may collect and maintain the sales tax in the account on behalf of the merchant 28 for a specified period, the sales tax to be remitted to the government entity 30 on a periodic basis (e.g., monthly, quarterly, yearly) in accordance with government entity guidelines.

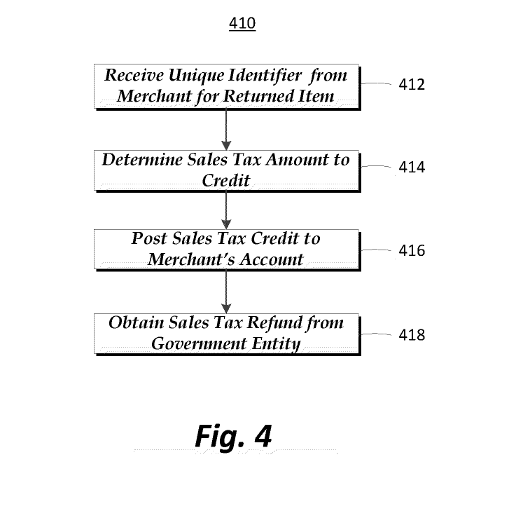

FIG. 4 is a flow diagram illustrating operations in process 410 for the return of a previously purchased item to the merchant and crediting the sales tax of the returned item to the merchant's sales tax account. For operation 412, “Receiving Unique Identifier from Merchant for Returned Item,” a merchant 28 may notify the distributor 18 that it has received a returned product. The merchant 28 may provide a unique identifier associated with the distribution item (e.g., distribution item ID 10), or product or transaction identifier to the distributor 18. With the unique identifier, the distributor 18 may retrieve from the distributor system 19, the record of the transaction. The unique identifier may be received from the merchant 28 electronically as data transmitted over a network as depicted in FIG. 1.

In operation 414, “Determine Sales Tax Amount to Credit,” the distributor 18 may determine the amount of sales tax that should be credited to the merchant's account based on the unique identifier. When the initial sales transaction was processed, the unique identifier was previously correlated with a transaction, a product or a distribution item 8 and included an associated sales tax amount. As part of the product return process, the merchant 28 may refund the buyer's purchase funds, the merchant 28 may also refund the sales tax amount paid by the buyer 12. Consequently, the merchant 28 must also be credited the amount of sales tax that it previously remitted to the government entity 30 (or was remitted on its behalf by the distributor 18). The amount of sales tax to credit to the merchant 28 may be determined from the unique identifier associated with the product or the distribution item 8. The distributor 18 may retrieve the amount of sales tax that was originally recorded against the unique identifier. This is the amount of sales tax that should be credited or refunded back to the merchant 28.

For operation 416, “Post Sales Tax Credit to Merchant's Account,” the distributor 18 may post a sales tax credit to the merchant's account for the amount of sales tax associated with the returned product. This is the amount of sales tax that was credited to the buyer 12 by the merchant 28 and now must be credited to the merchant 28 by the distributor 18. In some embodiments, this sales tax credit may act as a credit for future sales tax remittances to the government entity 30. As shown in operation 418, in some embodiments, the distributor 18 may seek a sales tax refund from the government entity 30 on behalf of the merchant 28. In such embodiments, the distributor 18 may submit all necessary data and/or documentation to the government entity 30 necessary to receive the refund on behalf of the merchant.

In certain other embodiments, the distributor may be tasked by the merchant to retrieve the returned product and return it to the merchant. A return label on the product or distribution item may include the original unique identifier for the product or distribution item 8. Thus, by knowing the unique identifier from the return label, the distributor 18 may be able to determine the amount of sales tax to credit to the merchant's account without receiving the product or distribution item unique identifier directly from the merchant 28.

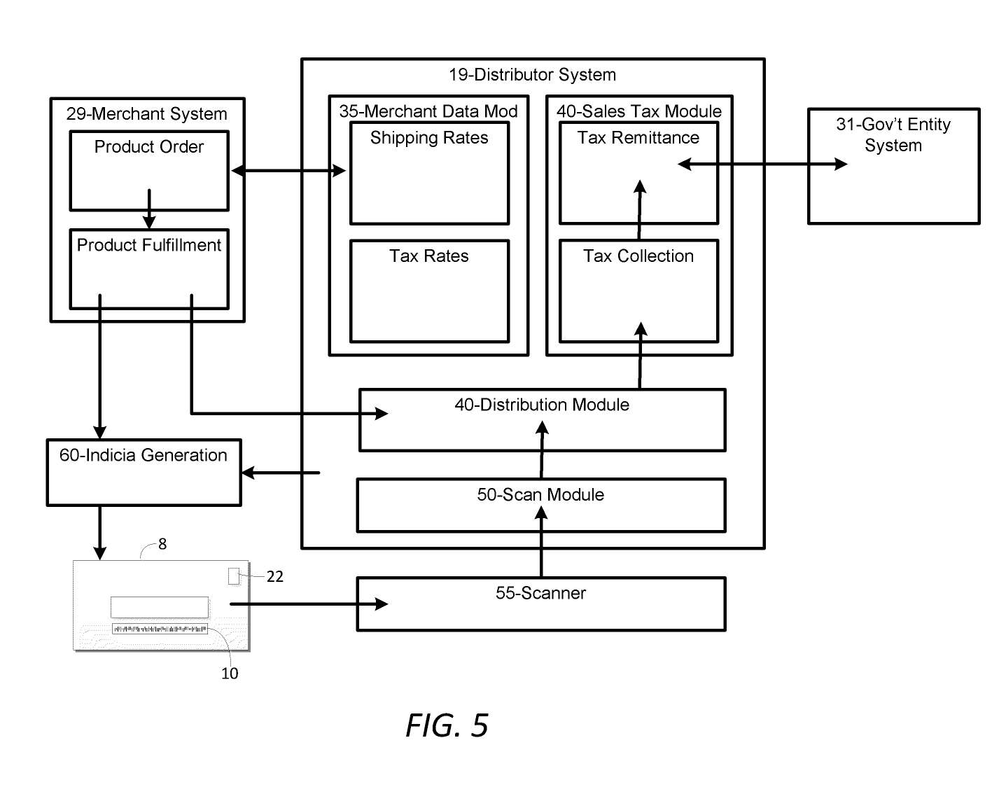

FIG. 5 depicts a block diagram of an embodiment a distributor system 19 for remittance of sales tax by a distributor 18 on behalf of a merchant 28 for one or more purchase transactions. FIG. 5 shows the distributor system 19 in communication with the merchant system 29 and the government entity system 31.

The distributor system 19 may include a merchant data module 35 which may be in communication with the merchant system 29. The merchant data module 35 may store shipping rates and tax rates associated with different geographic regions or shipping addresses. The merchant data module 35 of the distributor system 19 may transmit the shipping rate and tax rate to the merchant system 29 associated with a purchase transaction made by a buyer 12. The shipping rate and tax rate may be transmitted to the merchant system 29 in response to a data request from the merchant system 29. The purchase transaction may be completed by the merchant system 29 including fulfillment of the transaction. The merchant may package the product(s) as part of a distribution item 8. The merchant system 29 may transmit transaction data associated with the purchase transaction to the distributor system 19 to be received by, for example, a distribution module 40 to be stored in memory. As discussed above, the transaction data may include the distribution item ID, the shipping amount, the sales tax amount, the shipping address, the merchant ID and the like. In the distribution module 40, the sales tax amount for the purchase transaction may be associated with the merchant ID and the distribution item ID in the memory. As discussed above, the distributor 18 may receive the distribution item 8 from the merchant 28 for delivery to the shipping address provided by the buyer 12.

In one embodiment, an indicia 22 may be generated by the merchant 28. The merchant 28 may use an indicia generation device 60 that may be in communication with merchant system 29, such that the indicia generation device 60 generates an indicia 22 that includes at least the sales tax amount and may also include the shipping amount associated with the distribution item 8 and the purchase transaction. The indicia generation device 60 may also generate the distribution item ID 10. Thus, in this embodiment, the indicia 22 and the distribution item ID 10 may be affixed to the distribution item 8 prior to receipt of the distribution item 8 by the distributor 18.

In one embodiment, an indicia 22 may be generated by the distributor 18 and affixed to the distribution item 8. The distributor 18 may use an indicia generation device 60 in communication with the distribution system 19 to generate the indicia 22. The distributor 18 may generate the indicia 22 based on the transaction data received as input from the merchant system 29 in the distribution module 40 of the distributor system 19. The indicia generation device 60 may generate an indicia 22 that includes at least the sales tax amount and may also include the shipping amount associated with the distribution item 8 and the purchase transaction.

The distributor system 19 may be in communication with a scanner 55. The scanner may be used by the distributor 19 to scan the distribution item 8, to retrieve data from the distribution item ID 10 or the indicia 22. The scanned data may be transmitted to the distributor system 19 and may be received by a scan module 50. The scan module 50 may be in communication with the distribution module 40, wherein the scanned transaction data may be stored in memory of the distribution module 40.

The distribution module 40 may be in communication with a sales tax module 40 in the distributor system 19. The sales tax module 40 may track the tax collection received for a given merchant ID. The sales tax module 40 may also be in communication with the government entity system 31 to remit the sales tax to the government entity 30 and transmit the associated data (e.g., merchant ID) associated with the sales tax remittance.

The foregoing description details certain embodiments of the processes disclosed herein. It will be appreciated, however, that no matter how detailed the foregoing appears in text, the processes may be practiced in many ways. It should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment may be included with other depicted embodiments in any combination. For example, any of the various components described herein and/or depicted in the Figures may be combined, interchanged or excluded from other embodiments.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

Those of skill will further recognize that the various illustrative logical blocks, operations, modules, circuits, and algorithm steps described in connection with the embodiments disclosed herein may be implemented as electronic hardware, software stored on a computer readable medium and executable by a processor, or combinations of both. To clearly illustrate this interchangeability of hardware and software, various illustrative components, blocks, operations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the present invention.

The various illustrative logical blocks, operations, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may include one or more elements.

A person having ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Certain features that are described in this specification in the context of separate embodiments also can be implemented in combination in a single embodiment. Conversely, various features that are described in the context of a single embodiment also can be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Additionally, other embodiments are within the scope of the following claims. In some cases, the actions recited in the claims can be performed in a different order and still achieve desirable results.

What is claimed is:

1. A method of collecting and remitting a fee on behalf of a first entity for a purchase transaction made by a second entity from the first entity, the method comprising:
receiving a distribution item from the first entity for delivery to a shipping address, the distribution item comprising a distribution item ID and an indicia, wherein the distribution item ID comprises a merchant ID associated with the first entity and the indicia represents an amount comprising at least the fee amount for the purchase transaction;
receiving distribution item data, the data comprising the distribution item ID, the merchant ID, and the fee amount associated with the purchase transaction;
storing the distribution item ID, the merchant ID, and the fee amount in a memory;
associating the fee amount for the purchase transaction with the merchant ID and the distribution item ID in the memory;
delivering the distribution item to the shipping address;
transmitting the merchant ID and the fee amount associated with the distribution item ID to a government entity; and
remitting the fee to the government entity on behalf of the merchant.

2. The method of claim 1, wherein receiving distribution item data comprises receiving electronic transmittal data from the first entity.

3. The method of claim 1, wherein receiving distribution item data comprises scanning the distribution item ID on the distribution item.

4. The method of claim 1, wherein the indicia is in the form of postage affixed to the distribution item.

5. The method of claim 1, wherein the indicia represents an amount further comprising the shipping amount for the distribution item.

6. The method of claim 5, wherein the indicia indicates a total amount comprising the shipping amount and the fee amount.

7. The method of claim 5, wherein the indicia separately indicates the shipping amount and the fee amount.

8. The method of claim 1, further comprising accruing the fee received for multiple purchase transactions for a merchant prior to transmitting the merchant ID and the fee amount to the government entity and prior to remitting the fee to the government entity on behalf of the merchant.

9. The method of claim 1, further comprising receiving payment from the first entity for the cost of the indicia.

10. The method of claim 1, further comprising:
receiving purchase transaction data from the first entity, the purchase transaction data comprising the shipping address;
determining a sales tax rate and a shipping amount based on the shipping address; and
electronically transmitting the sales tax rate and the shipping amount to the first entity.

11. The method of claim 1, further comprising:
receiving purchase transaction data from the first entity, the purchase transaction data comprising the shipping address and a transaction amount;
determining a sales tax amount and a shipping amount on behalf of the first entity based on the transaction amount and the shipping address; and
electronically transmitting the sales tax amount and the shipping amount to the first entity.

12. The method of claim 1, wherein the government entity is a state government.

13. The method of claim 1, wherein the government entity is a county government.

14. The method of claim 1, wherein the shipping address and the first entity are located in the same state.

15. The method of claim 1, wherein the shipping address and the first entity are located in different states.

16. A system for collecting sales tax from a merchant for a purchase transaction between the merchant and a buyer and remitting the sales tax to a government entity on behalf of the merchant, the system comprising:
a memory;
a distribution module stored in the memory and configured to receive and store distribution item data associated with a distribution item, the distribution item data comprising a distribution item ID, a merchant ID associated with the merchant, and an indicia amount associated with the distribution item, the indicia amount being comprised of at least the sales tax amount associated with the purchase transaction;
a sales tax module stored in the memory and in communication with the distribution module and configured to receive and store at least the sales tax amount associated with a merchant ID;
a network component in communication with a merchant system and configured to receive the distribution item data from the merchant system; and
wherein the network component is further in communication with a government entity system and is configured to transmit data associated with the purchase transaction to the government entity.

17. The system of claim 16, wherein the indicia amount stored in the distribution model further comprises the shipping amount associated with the distribution item.

18. The system of claim 16, further comprising a scanner, the scanner configured to obtain the distribution item data from the distribution item.

19. The system of claim 18, further comprising a scan module, the scan module being in communication with the scanner, wherein the scan module is in communication with the distribution module to provide distribution item data to the distribution module.

20. The system of claim 16, wherein the distribution item data stored in the distribution module further comprises the sales tax amount.

21. The system of claim 16, wherein the indicia amount further comprises the shipping amount associated with the distribution item.

22. The system of claim 16, wherein the distribution item data stored in the distribution module further comprises the shipping amount.

23. The system of claim 16, further comprising a merchant data module stored in memory and configured to receive a shipping address and a purchase price associated with the purchase transaction from the merchant system.

24. The system of claim 23, further comprising a processing component in the merchant data module configured to calculate and store at least a sales tax amount associated with the purchase transaction based on the shipping address and the purchase price.

25. The system of claim 24, wherein the network component is configured to transmit the sales tax amount to the merchant system.
